(19) United States
(12) Patent Application Publication
(10) Pub. No.: US 2006/0080182 A1
(43) Pub. Date: Apr. 13, 2006

(54) Web-based size information system and method

(76) Inventors: Robert J. Thompson, Marietta, GA (US); Carmen Thompson, Marietta, GA (US); Victor A. Bergonzoli, Roswell, GA (US)

Correspondence Address: E.J. ASBURY III, LLC, 3330 CUMBERLAND BOULEVARD, SUITE 500, ATLANTA, GA, 30339-5985, US

(21) Appl. No.: 10/971,942

(22) Filed: Oct. 21, 2004

Related U.S. Application Data
(60) Provisional application No. 60/513,147, filed on Oct. 21, 2003.
(60) Provisional application No. 60/589,569, filed on Jul. 21, 2004.

(51) Int. Cl. G06Q 30/00

(52) U.S. Cl. 705/26

(57) ABSTRACT

A world-wide-web based size information system and method for providing any living thing with an accurate size information profile to facilitate the purchase of appropriately fitted products to help and support that living thing's needs. The inventive system includes; a size recording process, a database for online or offline input of the sizes, the ability to view and share the size information, grouping and sub-grouping of individual user information on demand, grouping and sub-grouping of system users on demand, comparison of system user sizes on demand, comparison of user sizes to an article on demand, cross reference of international sizes for a user, and the creation of an international size reference by country.

### CROSS-REFERENCE TO RELATED APPLICATIONS

This application claims the benefit of U.S. Provisional Application Ser. No. 60/513,147, filed on Oct. 21, 2003, and also claims benefit of U.S. Provisional Application No. 60/589,569, filed on Jul. 21, 2004.

### BACKGROUND OF THE INVENTION

1. Field of the Invention

The present invention relates to systems that provide sizing information and more particularly to a world wide web-based system and method of acquiring size information for living things and articles, storing the information, and making the information accessible via a centralized database for purposes of facilitating the sale and purchase of properly fitted articles. The system allows different parties to agree on actual size for any item being exchanged or purchased and also allows that data to be accumulated and measured statistically for an innumerable applications.

2. Description of the Related Art

It can be appreciated that size data have been in use for years. Typically, size data are comprised of sizing charts, manufacturing standard sizes, multiple international sizes and steps to measure and keep sizes on different supports.

The main problem with conventional size data are that none of them is answering the needs of the customers which is to have actual size data available and sharable simultaneously that can be used for product size comparisons and purchases on different supports such as the Internet or catalogues. Another problem with conventional size data is that no manufacturer known today transfers product dimensions in actual sizes such as inches or centimeters. Another problem with conventional size data are all sizing information such as Large, Medium or sizes 12 as an example are completely arbitrary by any manufacturers which makes the buying process arbitrary and confusing.

While these devices may be suitable for the particular purpose to which they address, they are not as suitable for providing any living things the correct dimensional identification to choose correct products to help and support that living thing's needs. The devices do not allow different parties to agree on actual size for any item being exchanged or purchased. The devices do not allow that data to be accumulated and measured statistically for an innumerable applications.

The main problem with conventional size data are that none of them is answering the needs of the customers which is to have actual size data available and sharable simultaneously that can be used for product size comparisons and purchases on different supports such as the Internet or catalogues. Another problem is that no manufacturer known today transfers product dimensions in actual sizes such as inches or centimeters. Also, another problem is all sizing information such as Large, Medium or sizes 12 as an example are completely arbitrary by many manufacturers which makes the buying process arbitrary and confusing.

In these respects, the web-based size information system and method according to the present invention substantially departs from the conventional concepts and designs of the prior art, and in so doing provides an apparatus primarily developed for the purpose of providing any living things the correct dimensional identification to choose correct products to help and support that living thing's needs. It allows different parties to agree on actual size for any item being exchanged or purchased. It allows that data to be accumulated and measured statistically for an innumerable applications. The system allows different parties to selectively share information of the parties and items. The system also enables the sale of items by comparing the relative sizes of parties and articles.

### SUMMARY OF THE INVENTION

In view of the foregoing disadvantages inherent in the known types of size data now present in the prior art, the present invention provides a new web-based size information system and method construction wherein the same can be utilized for providing any living things the correct dimensional identification to choose correct products to help and support that living thing's needs. The system allows different parties to agree on actual size for any item being exchanged or purchased. The system also allows that data to be accumulated and measured statistically for an innumerable applications.

The general purpose of the present invention, which will be described subsequently in greater detail, is to provide a new web-based size information system (the system) and method that has many of the advantages of the size data mentioned heretofore and many novel features that result in a new web-based size information system and method which is not anticipated, rendered obvious, suggested, or even implied by any of the prior art size data, either alone or in any combination thereof.

To attain this, the present invention generally comprises A) a size recording process B) a database for online or offline input of the sizes C) the ability to view and share the size information at any location D) the ability to track the progress of the information E) a Personal identification number generator for any user F) creation of history of trend analysis G) an access for any manufacturer to calibrate any object H) cross referencing manufacturing capabilities by geographic demands I) minimizing the number of manufacturing size requirements J) a filtered and secured access to third parties K) grouping and sub-grouping of individual information on demand L) grouping and sub-grouping of system users on demand M) comparison of user sizes on demand N) comparison of user sizes to an article on demand O) cross reference of international sizes for a user P) creation of international size reference by country.

The system provides a complete online methodology for all part of the body sizes input or object sizes, but moreover with the input of shapes (which toe is the longest, the same diameter of a skull but 2 different shapes). The key point here is that we keep the actual size data in centimeters or inches. A relational data-base that provides fields of information for true sizes and that is accessible partially or universally by authorized third parties. All the data are accessible or entered via the World Wide Web (Web). The system PIN or users' info are the key component for the shared information.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a web-based size information system and method that will overcome the shortcomings of the prior art devices.

An object of the present invention is to provide a web-based size information system and method for providing any living things the correct dimensional identification to choose correct products to help and support that living thing's needs. The system allows different parties to agree on actual size for any item being exchanged or purchased. The system also allows that data to be accumulated and measured statistically for an innumerable applications.

Another object is to provide a web-based size information system and method that is a database registering tool to record measurements of any living thing in an organized manner.

Another object is to provide a web-based size information system and method that the result of the gathered data is made available in a very controlled, unique and selective manner.

Another object is to provide a web-based size information system and method that gives consistent sizing information between parties exchanging or selling any objects where sizes are an important issue.

Another object is to provide a web-based size information system and method that aid in the benefits of process automation and control for just in time manufacturing.

Another object is to provide a web-based size information system and method that aid in reduced inventory demand by focusing on real size requirements for manufactured products or to be manufactured products.

Another object is to provide a web-based size information system and method that expand the users options on choosing competitive products based on correct sizes.

Another object is to provide a web-based size information system and method that is a source of information for any entity interested in data related to humans or animals sizes in certain market or locations.

Another object is to provide a web-based size information system and method that provides a method of sharing size information for living things and articles. In the system, a first user defines a user group related to a specific topic. The first user then identifies potential members of the user group including at least one second user. The first user, or the system, then identifies at least one of a plurality of measurements of at least one of a plurality of parts of a body as relevant data to the specific topic. The system then facilitates collecting the relevant data of the at least one second user, wherein the relevant data includes the at least one of the plurality of measurements of the at least one of the plurality of parts of the body of the at least one second user. The system then stores the relevant data collected for the at least one second user in a database. The first user requests the other potential members of the user group including the at least one second user to become a member of the user group. And the at least one second user accepts membership in the user group and allows the first user to access the relevant data of the at least one second user. The second user may allow other members of the user group to access the relevant data.

Another object is to provide a web-based size information system and method that provides a method of evaluating the compatibility of size information between living things and between living things and articles. A user of the system first identifies at topic. The user, or the system, then identifies at least one of a plurality of measurements of at least one of a plurality of parts of a body as relevant data to the topic. The system facilitates collecting the relevant data of a first user, wherein the relevant data includes at least one of the plurality of measurements of the at least one of the plurality of parts of the body of the first user. The system then stores the relevant data collected for the first user in a database. The system facilitates collecting the relevant data of an at least one second user, wherein the relevant data includes at least one of the plurality of measurements of the at least one of the plurality of parts of the body of the at least one second user. The system then stores the relevant data collected for the at least one second user in the database. The system processes the relevant data, including processing the relevant data collected for the first user, and the at least one second user, wherein the processing generates a first quality of fit between the at least one second user and the first user. And the system allows the at least one second user access to the first quality of fit.

Another object is to provide a web-based size information system and method that provides international size information for living things and articles. First, body dimension data associated with a user is collected in the system. The body dimension data includes at least one of a plurality of measurements of at least one of a plurality of parts of the body of the user. The system then stores the body dimension data in a database. Brand size information from at least one brand in a particular country is collected. The brand size information includes at least one of, size charts from brand catalogs, size charts from brand web-sites, and size data from a brand data base. The brand size information is stored for the at least one brand in the particular country, in the database. The body dimension data of the user is processed with each of the brand size information of the at least one brand, wherein the processing generates a user size for each of the at least one brand in the particular country. The user size from the at least one brand is processed, wherein the processing generates an international user size for the particular country. The body dimension data of the user may include a fit preference. The body dimension data and brand size data for a plurality of second users may be processed to generate a recommended size standard for articles in a particular country. The processing of the body dimension data of the plurality of second users with each of the brand size information of the at least one brand may include statistical analysis of the data.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is Global Summary of the system and method.

FIG. 2 illustrates an Arm and Leg measurement.

FIG. 3 illustrates a Foot measurement.

FIG. 4 illustrates a Hand measurement.

FIG. 5 illustrates a Head and Neck measurement.

FIG. 6 illustrates a Body measurement.

FIG. 7 illustrates the concept of how body measurement data can be calibrated with an article, such as a shirt.

FIG. 8. is a flowchart illustrating a process for sharing size information in accordance with an embodiment of the present invention.

FIG. 9 is a screen capture illustrating the concept of a “fitting room” and how it is created, in accordance with an embodiment of the present invention.

FIGS. 10-11 are screen captures illustrating the concept of sending an invitation to a possible member of a user group, in accordance with an embodiment of the present invention.

FIG. 12 is a screen capture illustrating a list of members of the user group for review by a user in accordance with an embodiment of the present invention.

FIG. 13 is a screen capture illustrating the process of creating International Size Information based upon size information from multiple brand articles from one or more countries, in accordance with an embodiment of the present invention.

FIG. 14 is a screen capture illustrating an International Size Information chart comparing sizes of listed articles in four different countries.

FIG. 15 is a screen capture illustrating a Size Chart by Brand wherein each listed brand name is a hypertext link to information describing properly sized articles for a user, in accordance with an embodiment of the present invention.

FIG. 16 is a screen capture illustrating a members system-determined proper size for listed articles under a particular brand, in accordance with an embodiment of the present invention.

FIG. 17 is a screen capture illustrating a members' system-determined proper size and allowing the member to select another size as “Best Fit” to be stored by the system, in accordance with an embodiment of the present invention.

FIG. 18 is a screen capture illustrating an access controllable community with a list of members who are able to share their size data with other members.

FIG. 19 is a screen capture illustrating the size data for a particular member.

FIG. 20 is a flowchart illustrating the process of matching appropriately sized articles with members based upon the members size data and fit criteria.

FIG. 21 is a flowchart illustrating the process of matching appropriately sized articles with members based upon the members' size data, the size data of an article, and fit criteria.

### DETAILED DESCRIPTION OF THE INVENTION

Turning now descriptively to the drawings, in which similar reference characters denote similar elements throughout the several views, the attached figures illustrate a web-based size information system and method (the system), which comprises A) a size recording process B) a database for online or offline input of the sizes C) the ability to view and share the size information at any location D) the ability to track the progress of the information E) a Personal identification number generator for any user F) creation of history of trend analysis G) an access for any manufacturer to calibrate any object H) cross referencing manufacturing capabilities by geographic demands I) minimizing the number of manufacturing size requirements J) a filtered and secured access to third parties K) grouping and sub-grouping of individual information on demand L) grouping and sub-grouping of system users on demand M) comparison of user sizes on demand N) comparison of user sizes to an article on demand O) cross reference of international sizes for a user P) creation of international size reference by country.

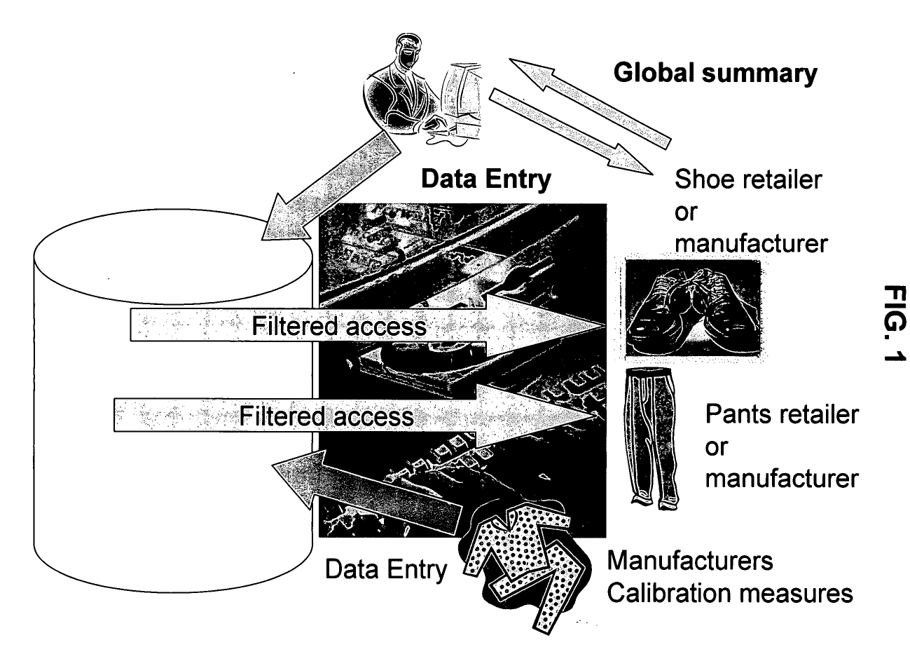

As illustrated in FIG. 1, the system provides a complete online methodology for all part of the body sizes input or object sizes, but moreover with the input of shapes (which toe is the longest, the same diameter of a skull but 2 different shapes). The key point here is that we keep the actual size data in centimeters or inches. A relational data-base that provides fields of information for true sizes and that is accessible partially or universally by authorized third parties. All the data are accessible or entered via the World Wide Web. A system PIN or users' info are the key component for the shared information.

The system provides a complete online methodology for all part of the body sizes input or object sizes, but moreover with the input of shapes (which toe is the longest, the same diameter of a skull but 2 different shapes). The key point here is that we keep the actual size data in centimeters or inches. The recording process is flexibly designed to accommodate few or an extensive number of dimensions on each body segment. The actual data can be measured or taken from any different source. In addition, users are able to enter data not related to sizes, such as color, preferred fabric, etc.

The user measurement methods are unique to the system. Sizes can only be recorded in actual inches, feet, miles or metric system. Describing the human forearm measuring procedure is an example of how all typical body extremities are measured including the torso and incorporated in to the structure to compose the whole anatomy dimensions.

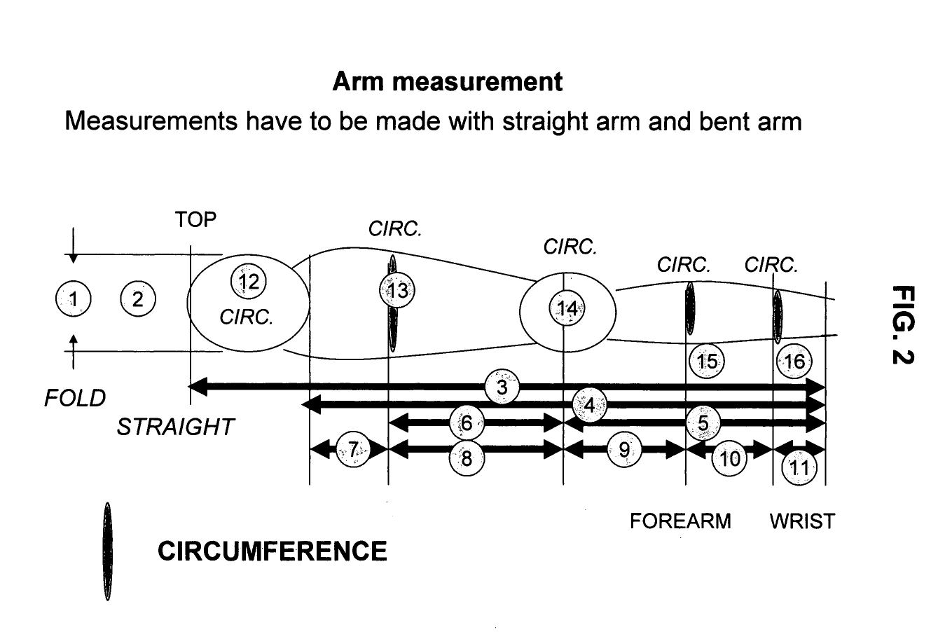

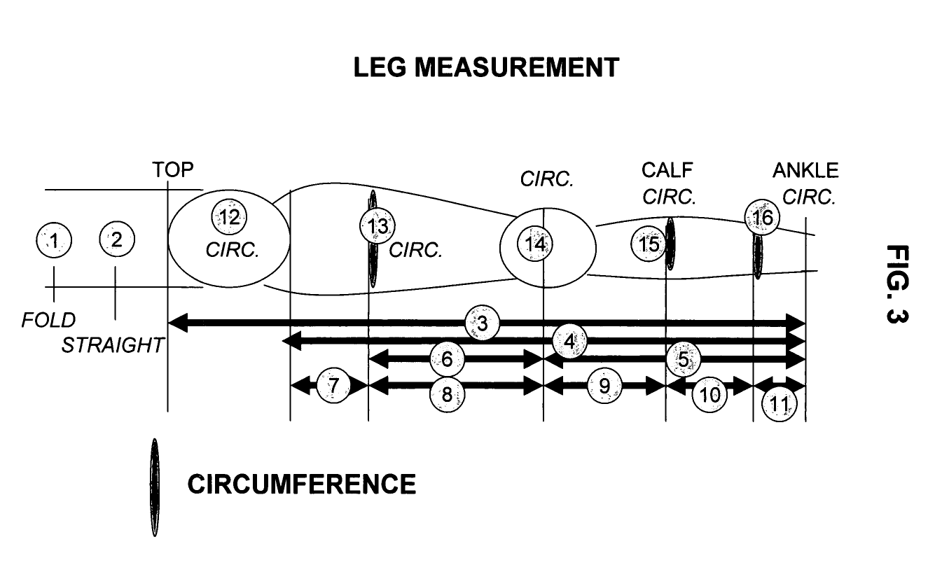

As illustrated in FIG. 2, in a fully functional system experience the forearm has at least eight separate dimensions to describe the correct shape to a third party. The forearm has at least four distinct diameters: wrist, lower forearm, upper forearm and the elbow. Furthermore the varying diameters are identified at specific distance from each other to provide a more complete identification of the total forearm configuration. Folding joint dimensions for the shoulders, elbows and knees are measured in both the extended or relaxed positions and the folded positions. As illustrated in FIG. 3, the leg has at least four distinct diameters and the varying diameters are identified at specific distance from each other to provide a more complete identification of the total leg configuration. All major body segments are identified in with same dimensioning procedure except the head, hands and feet.

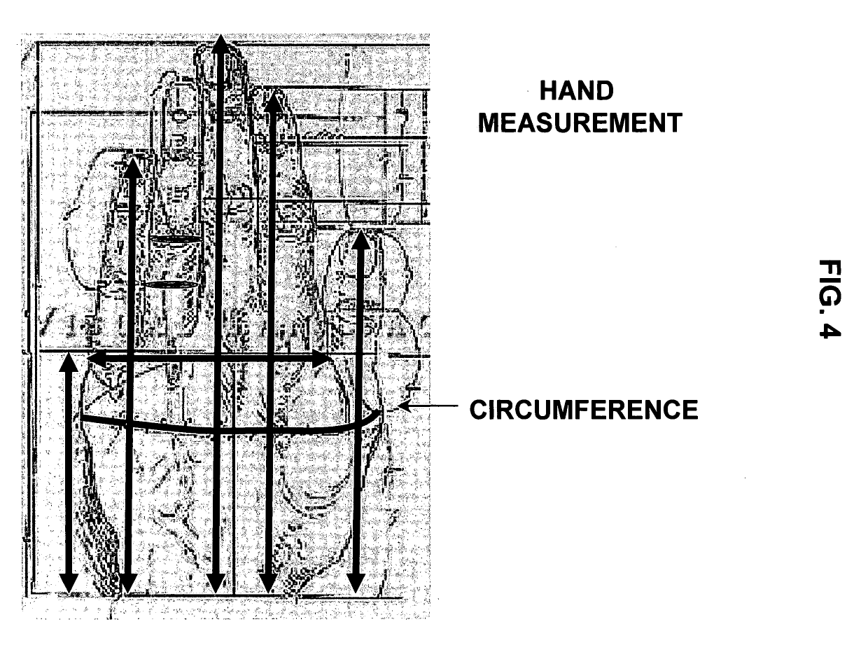

As illustrated in FIG. 4, hand shapes are very complex and require many dimensions. Sample glove dimensions are identified as in the forearm example including finger length, hand breadth and hand circumference.

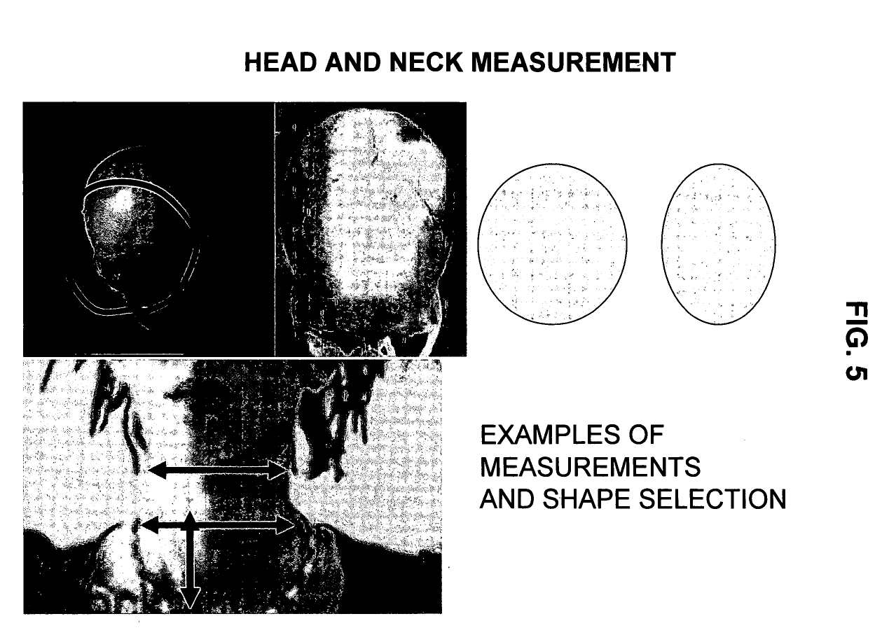

As illustrated in FIG. 5, head shapes can present a unique measuring problem. Starting with a minimal one simple circumference dimension to fit a hat and leading up to complex helmets, head and neck shapes require a plurality of measurements to fully describe.

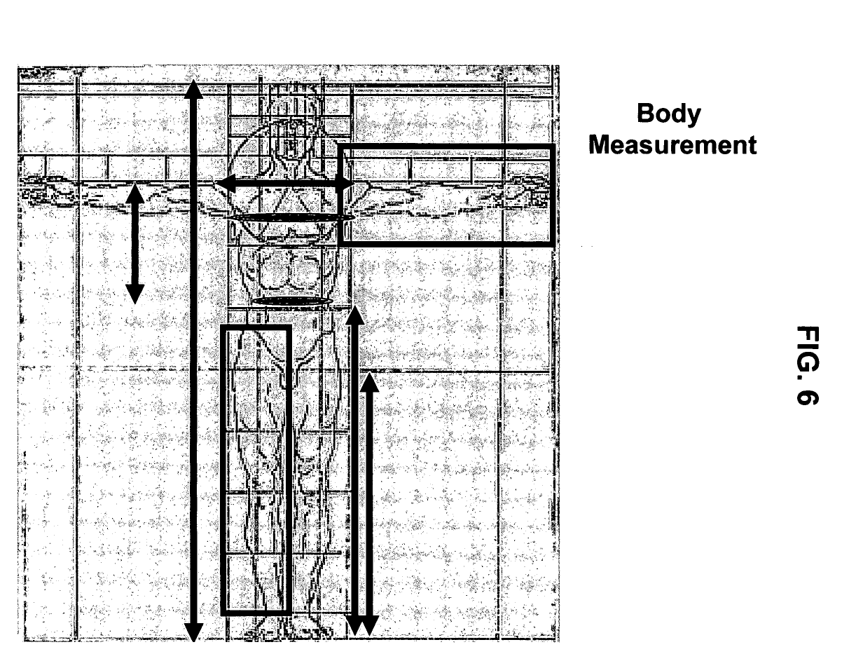

As illustrated in FIG. 6, the individual extremity measurements may be processed to form a complete body measurement. And the processed body measurement compared with actual measurements such as height and arm span to check the validity of the data.

All registered system users are provided a coded identification and a flexible Personal Identification Number (PIN). Coded identification is any continuous group of alpha numeric characters chosen by the user or given by the system. An attached and related PIN is a specific group of characters chosen by the computer with an ending group of at least three or more flexible characters to limit and control viewing access to specific data only. For example, an actual foot size (Not a shoe size) or overall height. Organizations are provided unique “invisible” identifiers to group selective users coded identification by organization identification. For example; any individual related to any Government, Army, Hospital, Corporation, School, Police, Church, etc. The system is also able to integrate any other measurement given by external sources or other methods and can integrate any existing data and not just new data.

The system provides a relational data-base that provides fields of information for true sizes and that is accessible partially or universally by authorized third parties. The Data-base keeps all the interrelated data entered during the recording process. It allows the manipulation of data for multiple uses such as filtered information needed by specific manufacturers (Actual foot size for a shoe manufacturer). The system also allows manufacturers to enter actual size data of their own product in order to match for fit and function. Registered system users can be grouped and queried in a infinite number of sub group relationships. For example; all Boy Scouts can belong to one major group and further selectively and simultaneously identified in to a smaller groups as a individual Troup Number. Any single “fully registered” registered user will have as many as, but not limited to, 300 fields of information available to record dimensional and identification data. Basic identifying information is or maybe required for correspondences and electronically automated payment methods from the user for use of the system subscription service.

The service can be free of charge as well or part of a more global offering. Partial registrations with minimal dimensional recording are available for limited periods to assist new user introductions. It is mandatory or actively recommended for each user to keep active maintain and update an active e-mail address. The system number can be as well printed by users when ordering through catalogs. An access is given to the vendor or supplier to retrieve the pertinent data. The system users may give their number at a retail location when shopping live. The articles that fit their size would then be easily accessible. The system users are able to add other data and information to their profile, such as (not limited to) preferred color, fabric, shape, etc.

The system users will have access to a summary of their particular size. The summary will contain as well a summary with some or a lot of details on the most likely size in their country or when they travel to any country they choose. They will be able to print such information for easy access. Additionally, the system users will be able to input and keep record of objects that fit their particular size, such as a golf club that was fitted by an external source.

The system allows manufacturers and retailers to enter in a dedicated format the data of their apparel, clothing, shoes, golf clubs, etc. Each specific data will then allow an easy match of any system user to a particular manufacturer's object. Objects can be produced before the system number is given or the system can serve as the basis for manufacturing, such as manufacturing a custom pair of shoes for a user.

All the data is accessible or entered via the World Wide Web (Web). The system PIN or users' info are the key component for the shared information. Anyone interesting in retrieving their size data will have access to the information over the internet. The Web will allow third parties to access info on one system user or specific data on a small or large population, provided that the third party has access to do so.

Data-recording is the first part of the process, it can be done offline or online. The data are then “uploaded” to the Data-Base. Data is changed in the data-base when new data is entered. The web is the ultimate sharing tool that will facilitate access to all the data. The web is as well the tool that is mainly used by the users to upload their data into the data-base. The user first measures and collects his/her actual size data by following the system methodology or by gathering third parties information. The user inputs the data via the Web or any other support into the system database. The user or any other person that has access to the data-base can retrieve data according to his needs. Manufacturers can input their actual size data of their own product in order to match for fit and function. The system is capable of delivering information on a particular user or on a group of users based on any criteria entered.

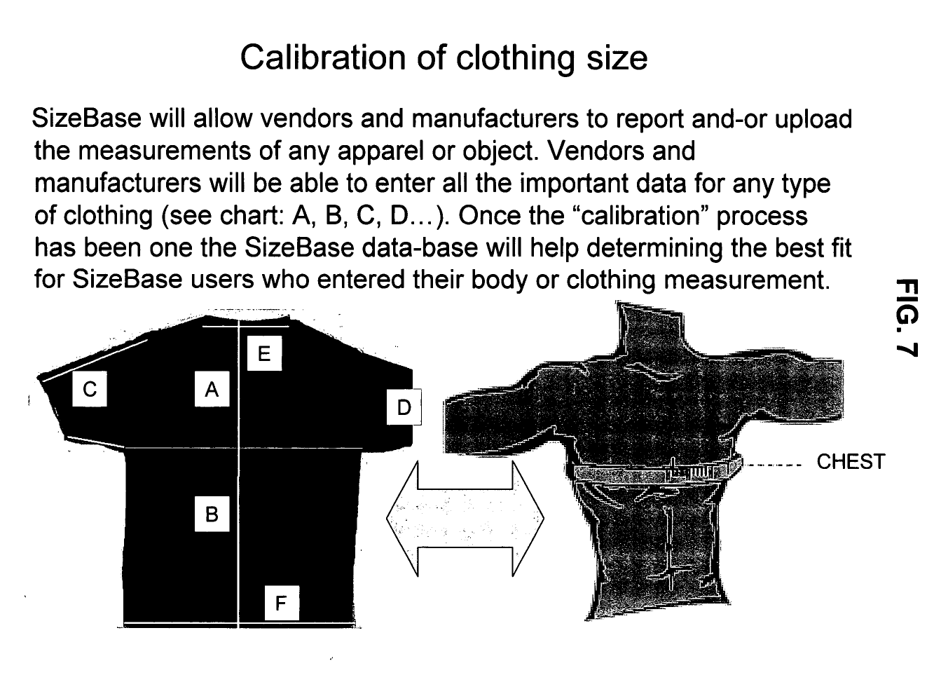

As illustrated in FIG. 7 in another embodiment, the web-based size information system (the system) will further allow vendors and manufactures to report and/or upload the measurements of any article, including clothing. As depicted in FIG. 7 for a shirt, vendors and manufacturers will be able to enter all the important measurement data for any type of article. The measurement data may include the physical dimensions of the article, and other physical properties of the article such as color, material weight, fabric weave, etc. The measurement data is subsequently “calibrated” to determine the best fit for users (e.g. prospective purchasers) who have entered their respective body or clothing measurements. The calibration is accomplished by comparing the physical dimensions of the article to the physical dimensions of the users, and noting the range of user sizes which each article may fit. Each vender or manufacturer size may then be “calibrated” to a range of user sizes, or in the alternative, each user size may be “calibrated” to a range of vender or manufacturer sizes.

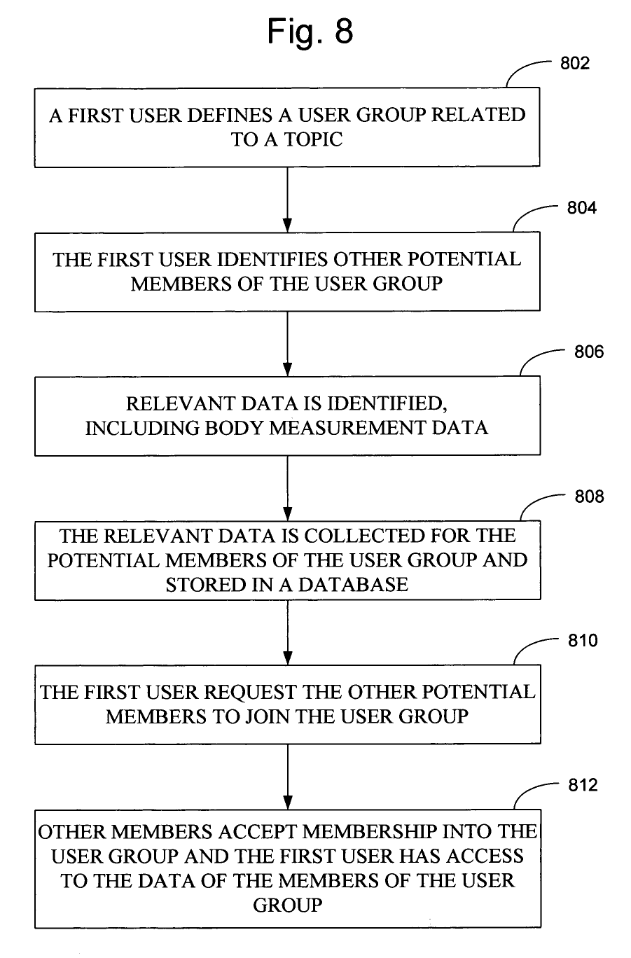

As illustrated in FIG. 8, in another embodiment the web-based information system will further allow a user to define a user group related to a particular topic 802. The user defining the user group may be referred to herein as a first user, or as the originator of the user group. The topic may be related to a sport, a job function, a particular kind of article of clothing, or another area where the user desires to gather the body dimension data for a group of individuals. The first user then identifies other potential members of the user group 804. The potential members may currently be users of the system, or may not yet be user of the system. The other potential members may be identified by a name, an electronic address, or by a unique identifying number known to the system, or by any other means of uniquely identifying an individual within the system.

The data which is relevant to the topic is then identified 806. The relevant data will include body dimension data of the potential members. The particular body dimensions of interest may be identified by the user, or may be identified by the system logic based upon the kind of article, sport, job function, or other criteria related to the particular topic of the user group. The relevant body dimension data is then collected and stored in a database 808. The relevant body dimension data for each potential member of the user group may already be present in the system if the potential member of the user group is already a user of the system, or the potential member may become a user of the system and enter his/her body dimension data into the database at that time, or at any later time. A user of the system may enter body dimension data, or update existing body dimension data, at any time by simply logging into the system and modifying their data.

As further shown in FIG. 8, the first user then requests or invites the potential members identified in 804 to join the user group 810. The potential members may not already be a user of the system, and may be requested to join both the system and the user group by electronic mail, or other electronic communication means. Alternatively, the potential members may already be users of the system and may simply be requested to join the user group electronically within the system. The potential members, who are users of the system, may accept membership in the user group 812 and allow the first user to access their relevant body dimension data identified in 806. The first user may then export the relevant body dimension data of the user group data out of the system for transfer to a vender or manufacturer. The relevant data may be exported to an electronic file, or may simply be in hardcopy format. In an alternative embodiment, each member of the user group may allow all members of the user group to access their relevant data, or may allow only selected members of the user group to access their relevant data.

In another alternative embodiment, the existence of the user group and the specific topic for which it relates may be published or available for review by other users of the system. Any user of the system may then request membership in the user group from the first user. The first user may then allow the other user to join the user group. In this embodiment, the first user has identified all users of the system as potential members of the user group, and the publication of the user group with the specific topic for which it relates is an open invitation to the other users of the system to join the user group.

In another alternative embodiment, the existence of the user group and the specific topic for which it relates may be available for review on the Web. An interested party may then join the system as a quest and request to join the user group. In this embodiment, the first user has identified all interested parties as potential members of the user group, and the publication of the user group with the specific topic for which it relates is an open invitation to other web users to join both the system, and to join the user group.

In another alternative embodiment, the invention of FIG. 8 may also comprise a fit preference defined by a member of the user group. The user may wish a loose fit, or a snug fit, or extra sleeve length, etc. The fit preference is then included in the relevant data available in the database to the other members of the group with access to the user data. The invention may also comprise a communication means between the members of the group. The system may enable communication between the first user and the other potential members of the user group, or between any user and any other user, or between any user and all other users.

In another alternative embodiment, the invention of FIG. 8 may comprise a merchant as a member of the user group. The merchant may be invited to join the user group by the first user. The merchant may also be a user of the system, and the existence of the user group and the specific topic for which it relates may be available for review on the system. The merchant may then request membership in the user group from the first user. The first user may then allow the merchant to join the user group. In this manner the merchant may be allowed to view the needs of the user group and offer services relevant to the user group and the specific topic.

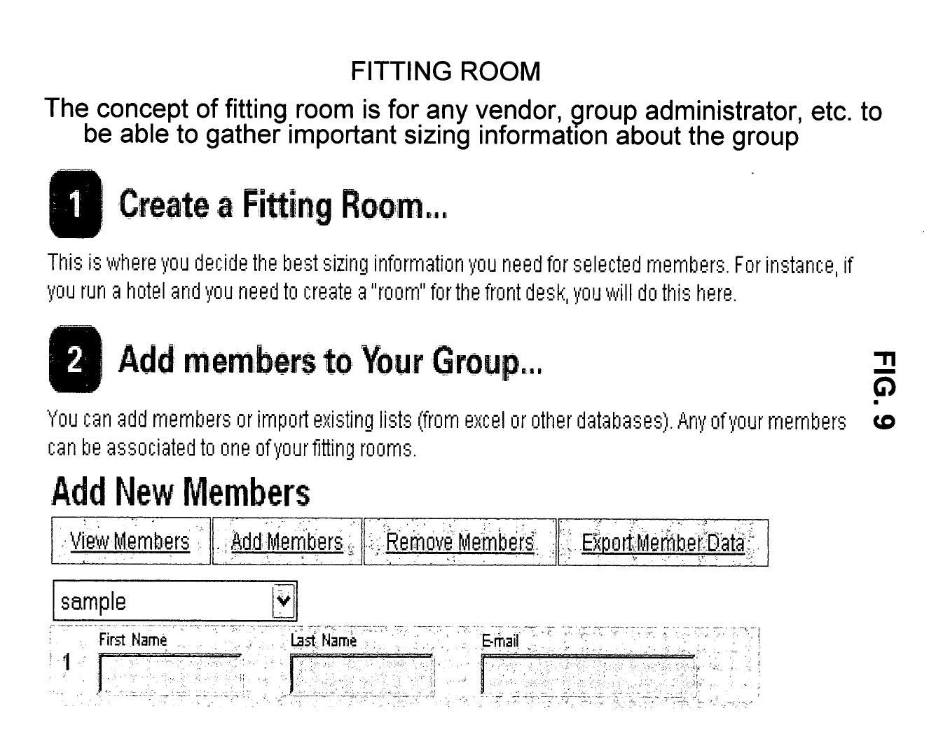

As shown in FIG. 9, one of the novel features of the system is the ability of the first users to create a virtual “Fitting Room”. The “fitting room” allows any vendor, group administrator, or other user to gather and store important sizing information about a group. The system provides the option of creating a “fitting room,” which encapsulates certain predetermined sizing information for selected members of the group. For instance, if the user is running a hotel he/she may have a need to create a “fitting room” for the front desk staff in order to obtain properly fitted uniforms. The “fitting room” will comprise each group member's size information for selected parts of the body (e.g. neck, arms, waist, etc.) as relevant data. When creating a fitting room, the user first creates a name for the fitting room. The user then enters each member's size data for the selected parts of the body. After a group is created, the user can add new members to the group or import existing lists of members from a spreadsheet or other databases. Any existing member(s) may be invited to join a particular fitting room. The existing members may then accept or decline membership in the fitting room.

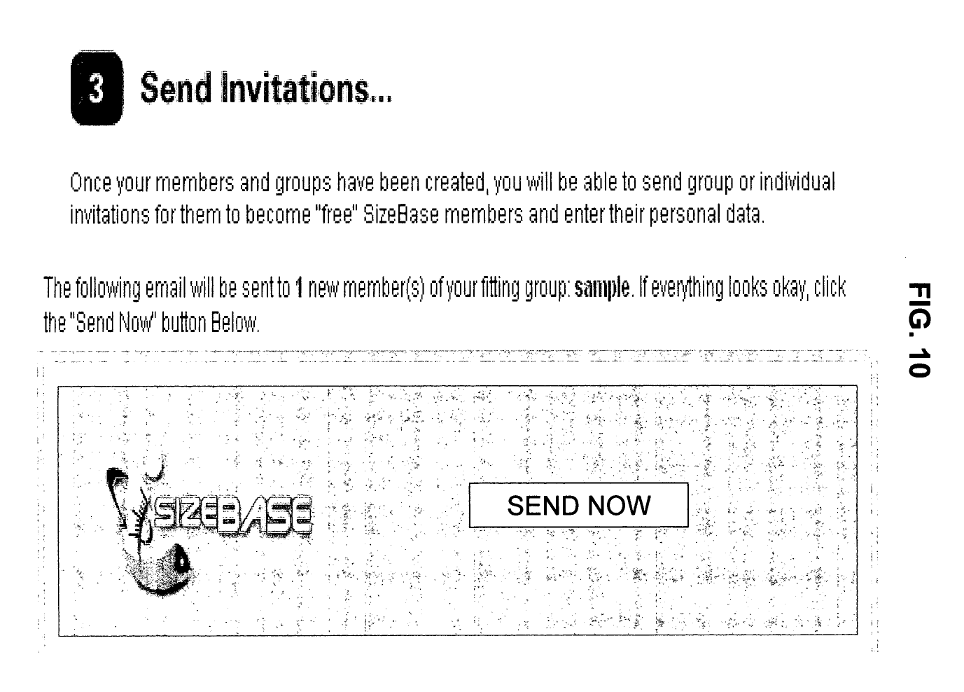

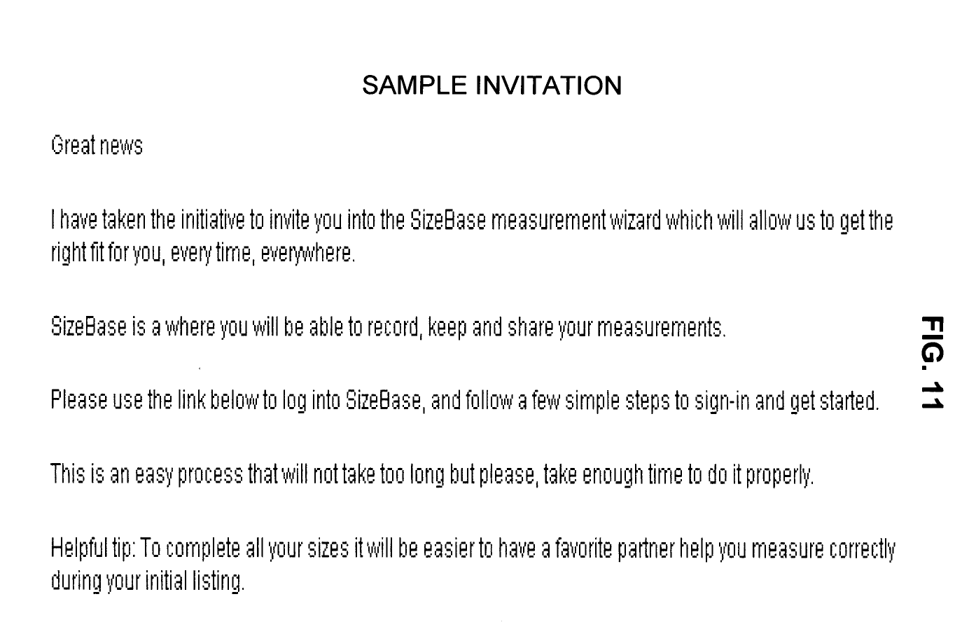

As shown in FIGS. 10 and 11, once member profiles and groups have been created, the user can e-mail invitations to a group or individual to become “free” members of the service. If the invitee chooses to join the service, he/she/they are asked a series of questions for purposes of creating a new member/group profile containing size data.

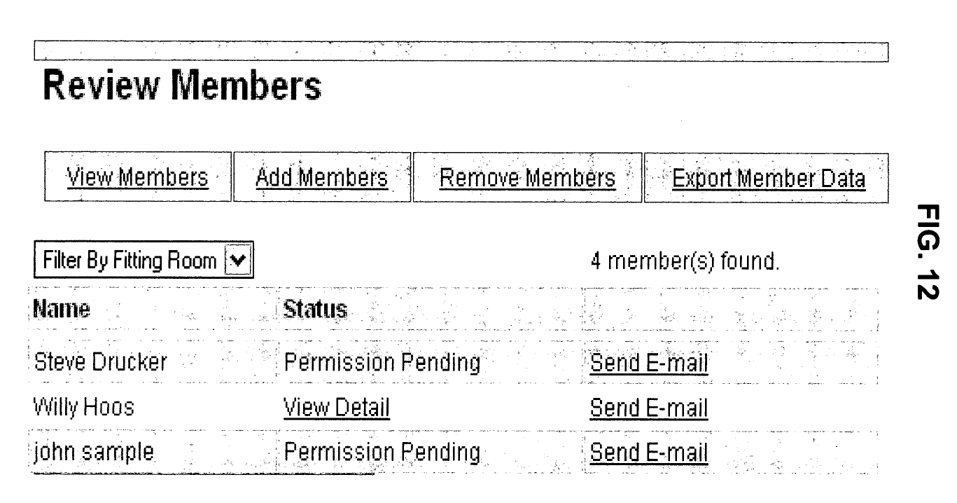

As shown in FIG. 12, the system further allows a user to analyze and use the size data in different ways. For example, a user can view a member's size data. Access to that information is available if the words “View Detail” are displayed next to a member's name. Display of the “View Detail” link indicates that potential member has accepted membership in the user group. To view the member's details, the user clicks on the words “View Detail,” which link the user to the member's size data.

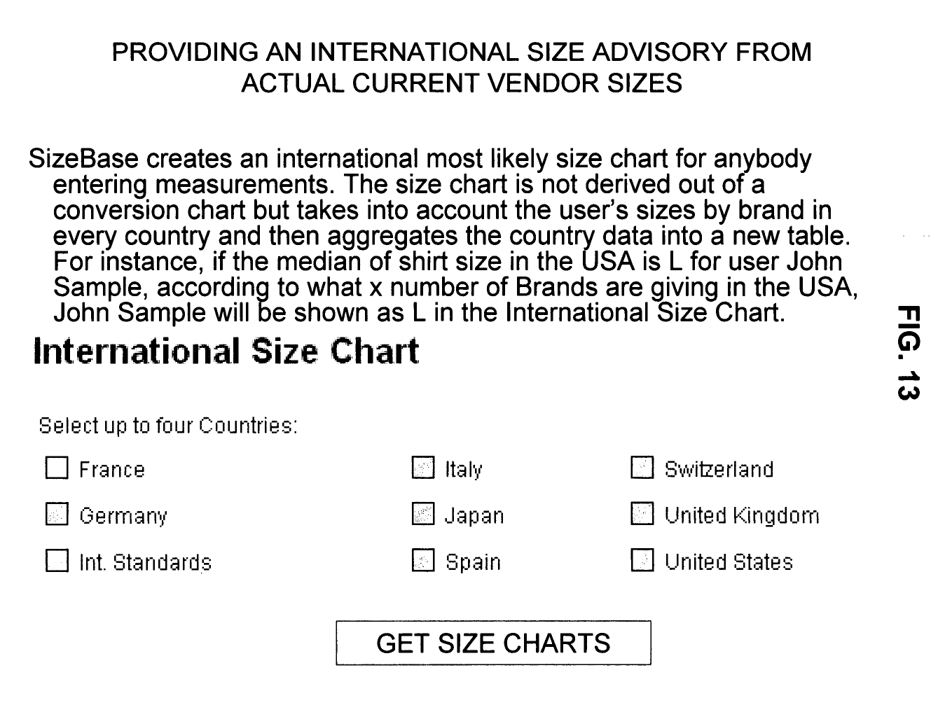

As shown in FIG. 13, in another embodiment, the system provides an international sizing standard that can be used to purchase properly fitted articles in any country. The international sizing standard is determined based on the median size of different brand articles within the same country. The sizing information from at least one brand within a country is collected based upon brand size charts or by other data supplied to the system by each particular brand. The article size for each brand article is then calculated by the system. The median size is then determined for that particular country. A brand may be articles from a particular manufacturer, or may be any association or individual which provides sizing information.

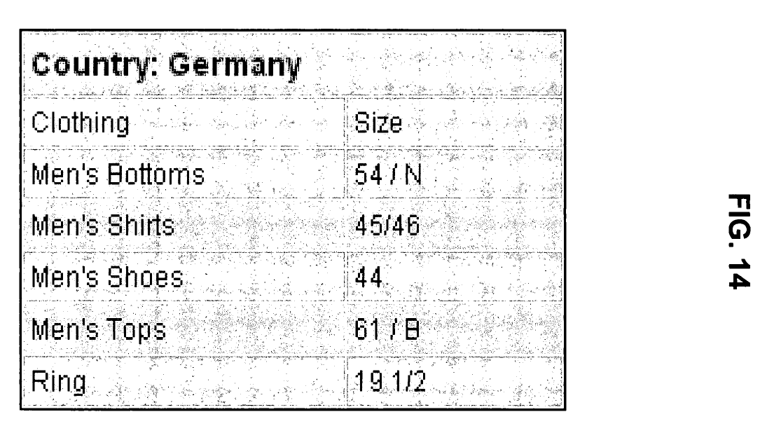

For example, if a user within the United States wishes to purchase French shirts. The system may have the size information of 5 French shirt brands. The system would then compare the sizing information available for each brand of French shirt to the size of the users dimensions as stored in the system to determine a proper shirt size in each brand of French shirt. The system would then determine the median size as the appropriate size French shirt for the user. This information will then allow the user to confidently shop for French shirts, over a range of brands, even if a particular brand is not present in the system database. As shown in FIG. 14, the system will also generate a chart displaying comparative sizes for one or more articles in two or more different countries. As further shown in FIG. 13, the countries are selected from a list of countries by checking the box corresponding to the country on the list.

In this embodiment, the system will also encourage vendors and manufacturers to adopt an international size standard. For instance, the system may include a compilation of brand size charts from which the system can generate a median size for each article sold by the brands. Alternatively, the system can generate a recommended international size for each article based on statistical analysis and data mining.

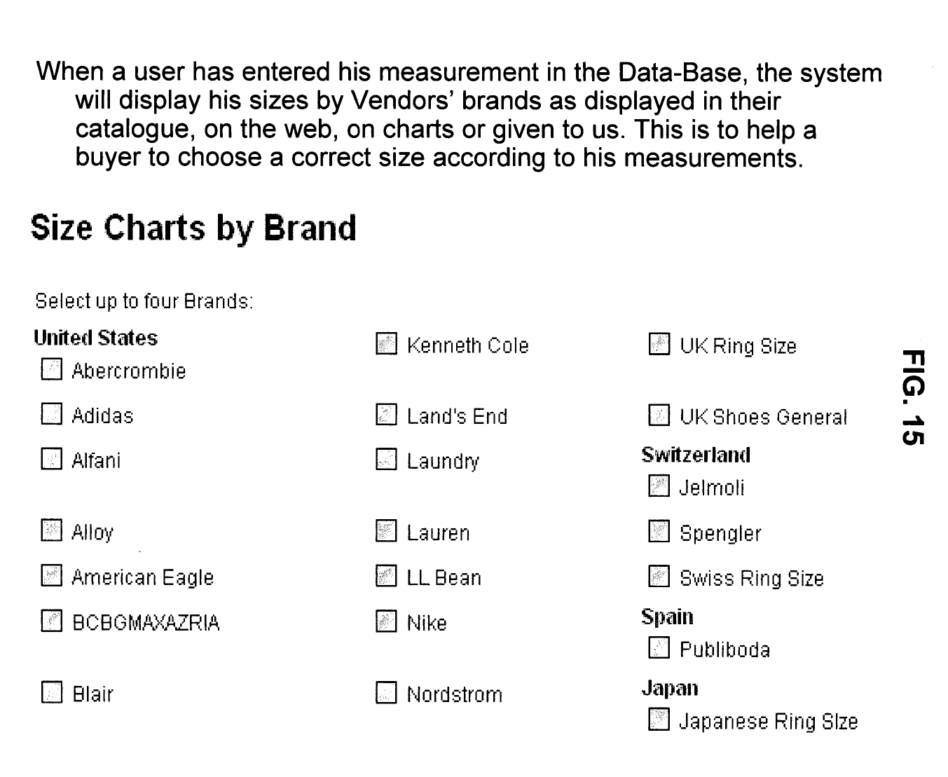

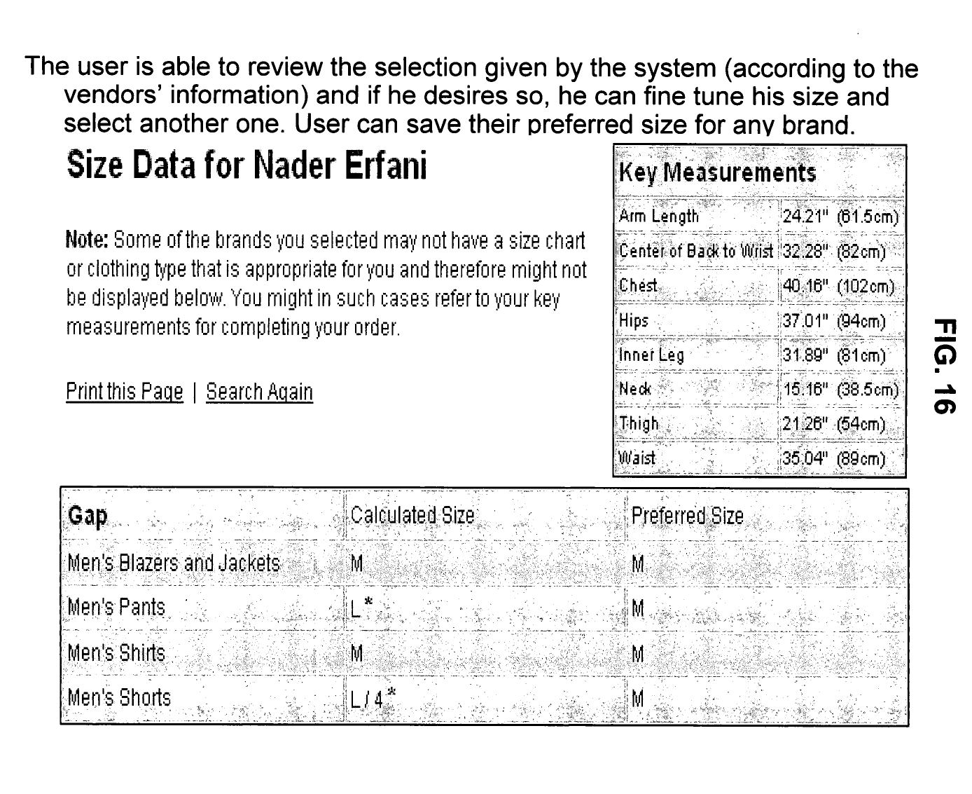

As shown in FIGS. 15 and 16, after a user has entered his measurements in the database, the system can display his system-determined appropriate size according to brand(s) and article(s) selected. This information helps a user (e.g. a prospective purchaser) to choose a properly sized brand of article based on his/her measurements.

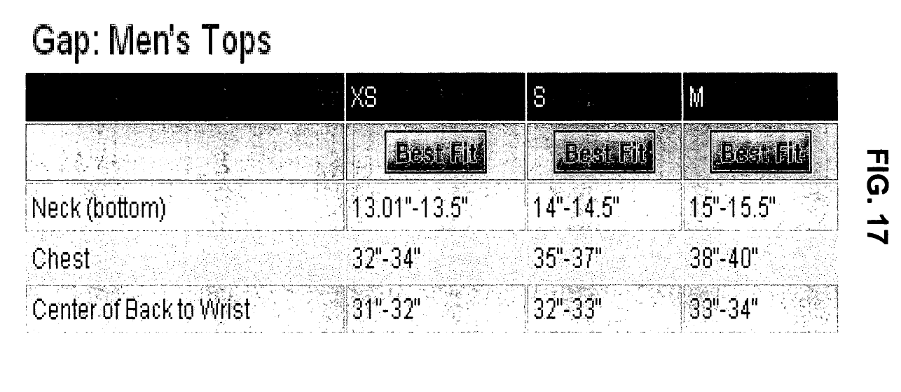

As shown in FIG. 17, while reviewing the brand and article selections generated by the system the user may edit his size information or the user may define a fit preference by selecting a different size than the one suggested by the system. For example, a user may prefer a loose fitting shirt in a particular casual brand, and may select the next larger size as his/her fit preference for that brand and article. After a user has edited his size, he/she clicks on the “Best Fit” button to save the new size as his/her preferred size for a particular article.

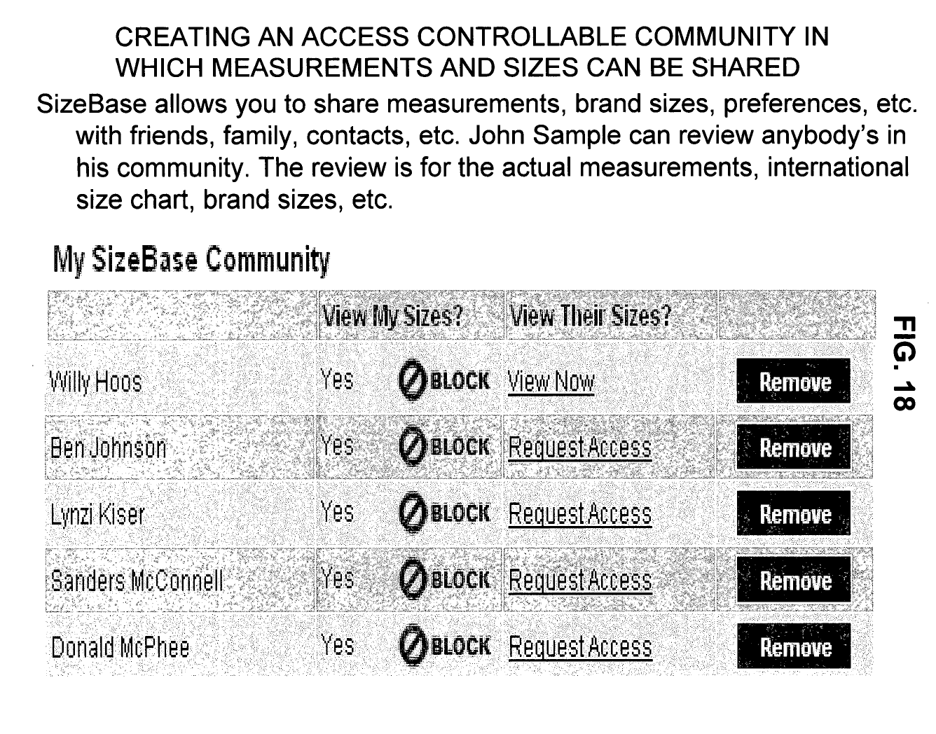

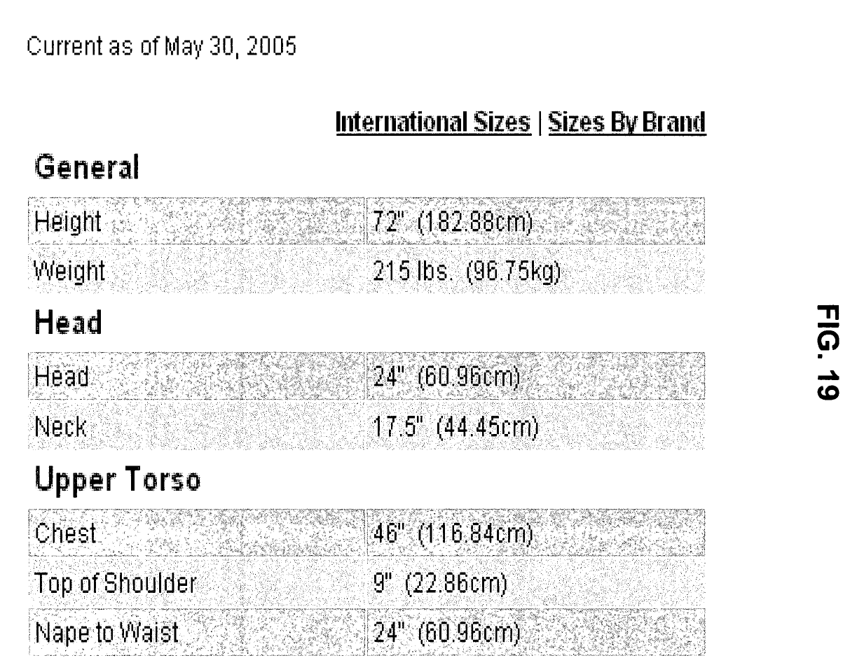

As shown in FIG. 18, in another embodiment, the system allows a plurality of geographically dispersed users, including vendors, manufacturers, and individual buyers and sellers, to share measurement information, brand sizes, and personal preferences in a centrally accessible database. The first user may request access to other user's data, or the other users may choose to join a user group and share their data with a selected group of users. Each user may then share his/her data with select other members of the user group or user community. As shown in FIG. 19, the user can review the other user's profiles to which he has been given access. The user profile includes actual measurement data, international size information in the form of a chart, particular brand sizes, user fit preferences and other information.

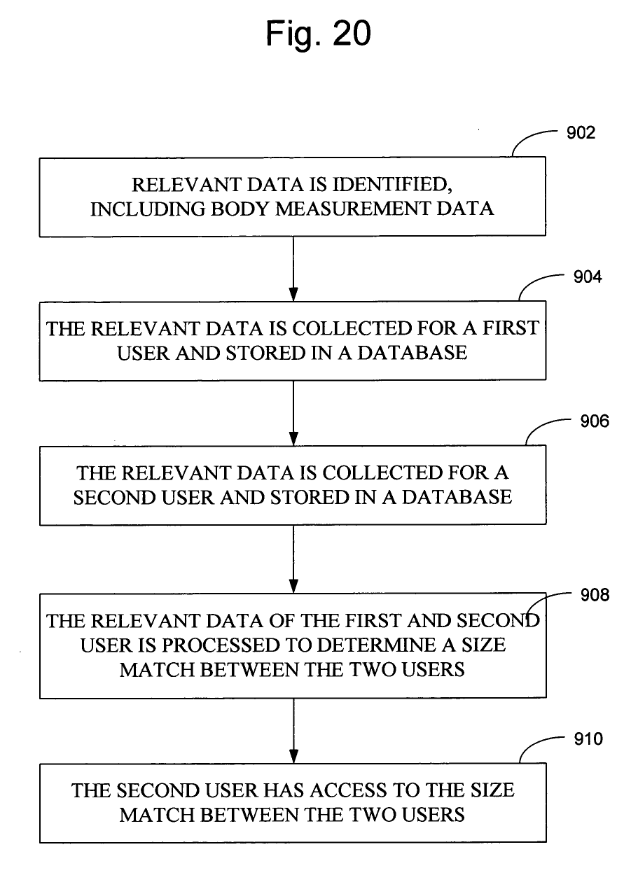

As illustrated in FIG. 20, in another embodiment, the system will also allow a user (first user) of the system to match sizes with another user (at least one second user or users) of the system based on each member's size data. A user of the system can choose to allow the system to compare his/her member size data with the other users on the system for a given topic. The topic may be general in nature wherein each user chooses to include all available body dimensions and the system may compare all available data available for all available system users. In this example, the system would inform each user which other users have a matching size. The topic may be more specific, wherein the topic may relate to a particular kind of article in which the first user is interested, a sport, a job function, or other criteria related to the first user. For example, the first user may be interested in selling a wedding dress, and define a topic related to wedding dresses. The other users of the system may then choose to make their sizes available based on interest in the topic of wedding dresses.

The first user may define and publish to other system users a topic on the system. In an alternative embodiment, the topic may also be defined by any system user, and the first user and at least one second user may choose to become a member of a user group associated with that topic.

In another alternative embodiment, the first user may publish their interest in the topic outside the system, and provide a means to identify the particular user on the system, such as a coded identification number, a link back to the user data, or other unique identification means on the system. For example, the topic may be published on the Web, on a web-site relevant to the topic, or on a web-site for the exchange or sale of articles. An individual may see the topic published on the Web and become an interested party. The interested party may then join the system as a guest and provide their relevant data. In this embodiment, the first user has published the topic for review by all Web users, and the publication of the topic is an open invitation to all Web users to join both the system, and to provide relevant data.

As further illustrated in FIG. 20, the data which is relevant to a topic is identified in 902. The relevant data will include the body dimension data of both the first and second users of the system. The particular body dimensions relevant to the topic may be identified by the first user, or may be identified by the system logic based upon the topic. For example, the first user may wish to sell a wedding dress. The system may be configured with a range of available topics covering common articles, sports, or other topics of common interests to users. The user would then select wedding dresses as a topic within the system, and system logic would determine which body dimension measurements are relevant to the topic of wedding dresses. The relevant body dimension data for the first user is then collected and stored in a database 904. The relevant body dimension data for the other users of the system is also collected and stored in the database 906. The relevant body dimension data for the other users of the system may already be present in the system, or may be added at a later time, when an individual becomes a user of the system based upon interest in the topic.

When the relevant body data for another user is available, the system compares each member's size data and determines a size match between the two users 908. The size match may be expressed as a quality of fit between the first user and the second user or users. The quality of fit may be expressed as simply as the user sizes match or do not match, or may be qualitatively expressed as slightly smaller, slightly larger, taller, shorter, or other terms as are known in the art.

The quality of fit may also be specific to a portion of the body, such as for the lower extremities, leg length, waist measurement, and inseam, or may be specific to an article of clothing, such as shirts, pants, or shoes, or any other comparison criteria defined by the user. The system may produce a plurality of quality of fits between the users comparing various portions of the body, or comparing portions of the body related to multiple articles of clothing. After the quality of fit between the first user and second user is determined, at least the second user may access the quality of fit data 910. If the first user chooses to allow access to his/her data, the quality of fit may also include the body dimension data of the first user and a comparison of the first user relevant body dimension data to the second user relevant body dimension data. In an alternative embodiment, both the first and second user may access the quality of fit data on the system.

In another alternative embodiment, the invention of FIG. 20 may also comprise a fit preference defined by the at least one second user of the system. The second user may wish a loose fit, or a snug fit, or extra sleeve length, etc. The fit preference is then included in the relevant data of the second user available in the database for comparison with the data of the first user.

In another alternative embodiment, the invention may also comprise the creation of a user group by the first user. As in the invention of FIG. 8, the at least one second user would be invited to join the user group after the system processes the quality of fit. The at least one second user may be invited to join the user group if the quality of fit is favorable, or may be invited to join the user group regardless of the quality of fit between the two users, based upon the second users interest in the topic. As in the invention of FIG. 8, the quality of fit and relevant data may be available for all members of the user group. Each member of the user group may control access to his/her relevant data by the other members of the user group.

In another alternative embodiment, the invention may comprise a communication means between the first user and the one or more second users. The system may enable communication between the first user and the other users, or between any user and any other user, or between any user and all other users.

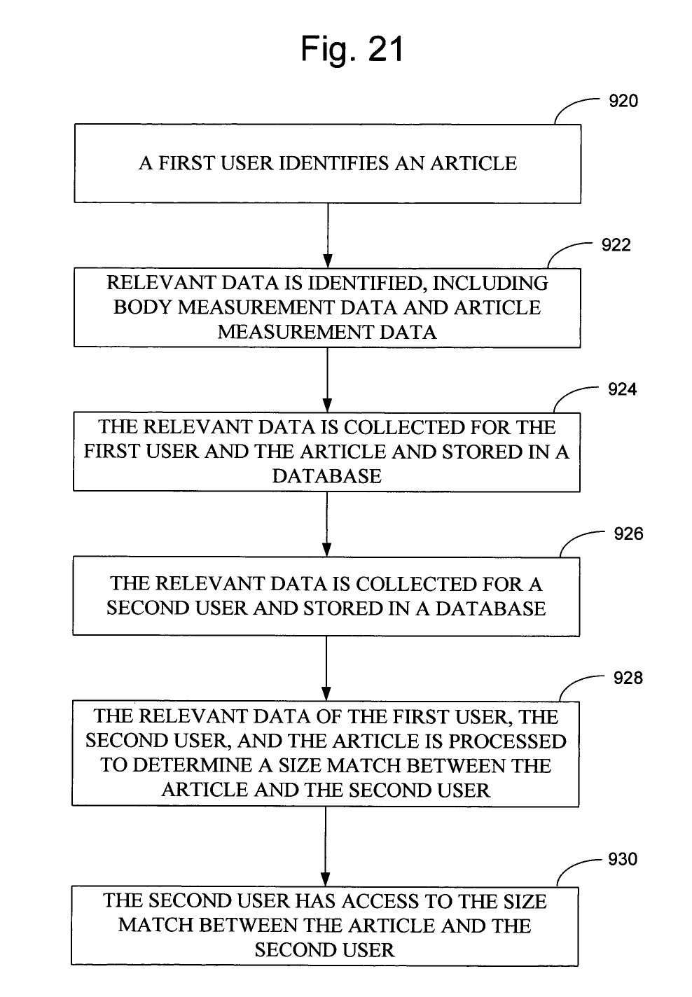

As illustrated in FIG. 21, in another embodiment, the system will allow the first user to include the size of an article as relevant data to the topic and for comparison with the other system users. In this example, the system would inform each user which has a matching size to the article. The article is identified in the system by the first user 920. The data which is relevant to the article is identified in 922. The relevant data will include dimension data of the article and a quality of fit between the article and the first user. The particular dimensions relevant to the article may be identified by the first user, or may be identified by the system logic based upon the topic. For example, in the example above, the first user may wish to sell a wedding dress. The system may be configured with a range of available topics covering common articles. The user would then select wedding dresses as a topic within the system, and system logic would determine which dimension measurements are relevant to the article of a wedding dress. The quality of fit may be expressed as simply that the article fits the first user, or may be qualitatively expressed as slightly tight, slightly loose, long, short, or other terms as are known in the art.

The relevant dimension data for the article is then collected by input of the first user and stored in a database 924. The relevant body dimension data for the at least one second user, or other users of the system is also collected and stored in the database 926. The relevant body dimension data for the other users of the system may already be present in the system, or may be added at a later time, when an individual becomes a user of the system based upon interest in the topic.

When relevant body data for another user is available, the system compares the first user body dimension data, the second user body dimension data, and the size data of the article and determines a size match between the at least one second user and the article 928. The size match may be expressed as a quality of fit between the second user and the article. The quality of fit may be expressed as simply as the article fits, or does not fit, or may be qualitatively expressed as slightly tight, slightly loose, longer, shorter, or other terms as are known in the art. The quality of fit may include the relevant dimension data of the article and a comparison of the article dimension data to the second user relevant body dimension data. If the first user chooses to allow access to his/her data, the quality of fit may also include the body dimension data of the first user and a comparison of the first user relevant body dimension data to the second user relevant body dimension data. After the quality of fit between the at least one second user and the article is determined, at least the second user may access the quality of fit data 930. In an alternative embodiment, both the first and second user may access the quality of fit data on the system.

In another alternative embodiment, the at least one second user may identify a second article for inclusion as relevant data in the system. As in the invention of FIG. 21 for the first user, the second user would enter the relevant article dimension data for the second article and a quality of fit between the second user and the second article. The system would then compare the first user body dimension data, the second user body dimension data, and the size data of the second article and determines a quality of fit between the first user and the second article. The first user may then access the quality of fit data.

In another alternative embodiment, the invention may also comprise the creation of a user group by the at least one second user. As in the invention of FIG. 8, the first user would be invited to join the user group after the system processes the quality of fit between the first and second users, or between the first user and an article. The first user may be invited to join the user group if the quality of fit is favorable, or may be invited to join the user group regardless of the quality of fit between the two users, based upon the first interest in the topic. As in the invention of FIG. 8, the quality of fit and relevant data may be available for all members of the user group defined by the first user, and each member of the user group may control access to his/her data by the other members of the user group.

As an illustrative example to the invention above, a user of the system may wish to sell a wedding dress. The user would enter her relevant body dimension data in the system, and may also enter size data of the wedding dress. The user may then create a topic of system related to the sale of her wedding dress. The topic, the sale of a wedding dress, may be published outside the system on the Web. The topic may be published on a web-site dedicated to the sale of goods, or on a web-site related to weddings. Interested parties may note the existence of the wedding dress for sale, and wish to determine if the dress could fit them. A link in the advertisement for the wedding dress may connect the interested party with the system database and the particular topic. The interested parties would become a second user of the system by entering their relevant body size data as queried by the system based upon the topic. The system would then determine a quality of fit between the second user and the wedding dress and provide the quality of fit to the second user. The system may then enable the sale of the wedding dress by enabling communication between the first user and the second user.

The foregoing is considered as illustrative only of a preferred embodiment of the the principles of the invention. Further, since numerous modifications and changes will readily occur to those skilled in the art, it is not desired to limit the invention to the exact construction and operation shown and described. It is to be understood that certain changes may be made in the forms and arrangement of the elements and steps of the method for a web-based size information system and method without departing form the underlying spirit and scope of the invention.

What is claimed is:

1. A method of sharing size information for living things and articles comprising the steps of:
a first user defining a user group related to a specific topic;
the first user identifying potential members of the user group including at least one second user;
identifying at least one of a plurality of measurements of at least one of a plurality of parts of a body as relevant data to the specific topic;
collecting the relevant data of the at least one second user; wherein the relevant data includes the at least one of the plurality of measurements of the of at least one of the plurality of parts of the body of the at least one second user;
storing the relevant data collected for the at least one second user in a database;
the first user requesting the other potential members of the user group including the at least one second user to become a member of the user group; and
the at least one second user accepting membership in the user group and allowing the first user to access the relevant data of the at least one second user.

2. The method as recited in claim 1, wherein the first user identifies the at least one of a plurality of measurements of the at least one of a plurality of parts of a body as relevant data to the specific topic.

3. The method as recited in claim 1, wherein a code segment of a computer program identifies the at least one of a plurality of measurements of the at least one of a plurality of parts of a body as relevant data to the specific topic.

4. The method as recited in claim 1, further comprising;
collecting the relevant data of the first user; wherein the relevant data includes the at least one of the plurality of measurements of the of at least one of the plurality of parts of the body of the first user;
the first user then allowing the at least one second user to access the relevant data of the first user.

5. The method as recited in claim 1, further comprising:
the at least one second user defining a fit preference; and
wherein collecting the relevant data of the at least one second user includes collecting the fit preference of the at least one second user.

6. The method as recited in claim 1, further comprising at least one of:
allowing the first user to communicate with the other potential members of the user group by sending a message to the database,
allowing the first user to communicate with the at least one second user by sending a message to the database, and
allowing the at least one second user to communicate with the first user by sending a message to the database.

7. The method as recited in claim 1, wherein the database is a centralized database accessible throughout the world.

8. The method as recited in claim 1, further comprising assigning a unique identifier to at least one of the first user and the at least one second user to allow access to the database.

9. The method as recited in claim 8, wherein at least one of the first user and the at least one second user are allowed to access the database by presenting the unique identifier.

10. The method as recited in claim 8, wherein at least one of the first user and the at least one second user go thru a registration process in order to receive the unique identifier.

11. The method as recited in claim 1, further comprising:
the first user identifying members of the user group including at least one merchant;
wherein the first user allows the at least one merchant to access the relevant data of the at least one second user.

12. The method as recited in claim 11, further comprising assigning a unique identifier to the at least one merchant to allow access to the database.

13. The method as recited in claim 11, wherein the at least one merchant is allowed to access the database by presenting the unique identifier.

14. The method as recited in claim 11, wherein the at least one merchant goes through a registration process in order to receive the unique identifier.

15. A system for sharing size information for living things and articles comprising the steps of:
a server computer;
a database, stored on the server computer, including a potential user group identified by a first user and related to a specific topic, wherein the user group includes at least one second user;
logic that identifies at least one of a plurality of measurements of at least one of a plurality of parts of a body as relevant data to the specific topic;
the database including relevant data of the at least one second user, wherein the relevant data includes the at least one of the plurality of measurements of the of at least one of the plurality of parts of the body of the at least one second user;
logic which requests the other potential members of the user group including the at least one second user to become a member of the user group;
logic which allows the at least one second user to accept membership in the user group and allows the first user to access the relevant data of the at least one second user in the database.

16. The system as recited in claim 15, wherein the logic used to identify the at least one of a plurality of measurements of the at least one of a plurality of parts of a body as relevant data to the specific topic, comprises selection by the first user.

17. The system as recited in claim 15, further comprising logic that suggest to the first user the at least one of a plurality of measurements of the at least one of a plurality of parts of a body as relevant data appropriate to the specific topic based on at least one of the sport involved, the activity involved, the clothing articles involved, and user preferences.

18. The system as recited in claim 15, wherein the relevant data associated with the at least one second user includes a fit preference defined by the at least one second user.

19. The system as recited in claim 15, wherein the database is a centralized database accessible from locations throughout the world.

20. The system as recited in claim 15, further comprising logic that assigns a unique identifier to at least one of the first user and the at least one second user to allow access to the database.

21. The system as recited in claim 20, wherein at least one of the first user and the at least one second user are allowed to access the database by presenting the unique identifier.

22. The system as recited in claim 20, wherein at least one of the first user and the at least one second user go thru a registration process in order to receive the unique identifier.

23. The system as recited in claim 15, further comprising:
the database including at least one merchant identified by the first user; and
logic which allows the at least one merchant to accept membership in the user group and allows the at least one merchant to access the relevant data of the at least one second user in the database.

24. The system as recited in claim 23, further comprising logic that assigns a unique identifier to the at least one merchant to allow access to the database.

25. The system as recited in claim 23, wherein the at least one merchant is allowed to access the database by presenting the unique identifier.

26. The system as recited in claim 23, wherein the at least one merchant goes through a registration process in order to receive the unique identifier.

27. The system as recited in claim 23, wherein which of the plurality of measurements of the second user that the at least one merchant can access from the database is verified upon presentation of the unique identifier.

28. A method of evaluating the compatibility of size information between living things and between living things and articles comprising the steps of:
a system user identifying a topic;
identifying at least one of a plurality of measurements of at least one of a plurality of parts of a body as relevant data to the topic;
collecting the relevant data of a first user, wherein the relevant data includes at least one of the plurality of measurements of the of at least one of the plurality of parts of the body of the first user,
storing the relevant data collected for the first user in a database;
collecting the relevant data of an at least one second user, wherein the relevant data includes at least one of the plurality of measurements of the at least one of the plurality of parts of the body of the at least one second user;
storing the relevant data collected for the at least one second user in the database;
processing the relevant data, including processing the relevant data collected for the first user, and the at least one second user, wherein the processing generates a first quality of fit between the at least one second user and the first user; and
allowing the at least one second user access to the first quality of fit.

29. The method as recited in claim 28, wherein the first user identifies the at least one of a plurality of measurements of at least one of a plurality of parts of a body as relevant data to the topic.

30. The method as recited in claim 28, wherein a code segment of a computer program identifies the at least one of a plurality of measurements of the at least one of a plurality of parts of a body as relevant data to the topic.

31. The method as recited in claim 28, further comprising:
the at least one second user defining a fit preference; and
wherein processing the relevant data includes processing the fit preference of the at least one second user.

32. The method as recited in claim 28, further comprising;
the first user defining a user group related to the topic; and
wherein the at least one second user is invited to the user group based upon the first quality of fit.

33. The method as recited in claim 28, further comprising:
the first user identifying a first article;
identifying at least one of a plurality of measurements of at least one of a plurality of parts of the first article as relevant data;
wherein collecting the relevant data of the first user, includes collecting at least one of the plurality of measurements of the at least one of the plurality of parts of the first article;
wherein processing the relevant data, includes processing the at least one of the plurality of measurements of the at least one of the plurality of parts of the first article, wherein the processing generates a second quality of fit between the at least one second user and the first article; and
allowing the at least one second user access to the second quality of fit.

34. The method as recited in claim 33, further comprising;
the first user defining a user group related to the topic; and
wherein the at least one second user is invited to the user group based upon the second quality of fit.

35. The method as recited in claim 33, further comprising:
the first user identifying a third quality of fit between the first user and the first article; and
wherein processing the relevant data, includes processing the third quality of fit.

36. The method as recited in claim 28, further comprising:
the at least one second user identifying a second article;
identifying at least one of a plurality of measurements of at least one of a plurality of parts of the second article as relevant data to the topic;
wherein collecting the relevant data of the at least one second user, includes collecting the at least one of a plurality of measurements of the at least one of a plurality of parts of the second article;
the at least one second user defining a fourth quality of fit between the second article and the at least one second user; and
wherein processing the relevant data, includes processing the at least one of the plurality of measurements of the at least one of the plurality of parts of the second article and the fourth quality of fit, wherein the processing generates a fifth quality of fit between the second article and the first user; and
allowing the first user access to the fifth quality of fit.

37. The method as recited in claim 36, further comprising;
the at least one second user defining a user group related to the topic; and
wherein the first user is invited to the user group based upon the fifth quality of fit.

38. The method as recited in claim 28, wherein the database is a centralized database accessible throughout the world.

39. The method as recited in claim 28, further comprising assigning a unique identifier to at least one of the first user and the at least one second user to allow access to the database.

40. The method as recited in claim 39, wherein at least one of the first user and the at least one second user are allowed to access the database by presenting the unique identifier.

41. The method as recited in claim 39, wherein at least one of the first user and the at least one second user go thru a registration process in order to receive the unique identifier.

42. The method as recited in claim 28, further comprising at least one of:
routing the first quality of fit from the database to the at least one second user,
allowing the at least one second user to communicate with the first user by sending a message to the database, and
allowing the first user to communicate with the at least one second user by sending a message to the database.

43. A system for evaluating the compatibility of size information between living things and between living things and articles comprising the steps of:
a server computer;
a data base, stored on the server computer;
logic that identifies at least one of a plurality of measurements of at least one of a plurality of parts of a body as relevant data to a topic;
the database including relevant data of a first user, wherein the relevant data includes the at least one of the plurality of measurements of the of at least one of the plurality of parts of the body of the first user,
the database including the relevant data of an at least one second user, wherein the relevant data includes at least one of the plurality of measurements of the at least one of the plurality of parts of the body of the at least one second user;
logic which processes the relevant data, including processing the relevant data collected for the first user, and the at least one second user, wherein the processing generates a first quality of fit between the at least one second user and the first user; and
logic which allows the at least one second user access to the first quality of fit.

44. The system as recited in claim 43, wherein the logic used to identify the at least one of a plurality of measurements of at least one of a plurality of parts of a body as relevant data to the topic, comprises selection by the first user.

45. The system as recited in claim 43, further comprising logic that suggests to the first user the at least one of a plurality of measurements of the at least one of a plurality of parts of a body as relevant data based on at least one of the topic, the kind of article, the activity involved with the article, and user preferences.

46. The system as recited in claim 43, further comprising:
the relevant data of the at least one second user including a fit preference; and
the logic which processes the relevant data, includes processing the fit preference of the at least one second user.

47. The system as recited in claim 43, further comprising:
the first user defining a user group based upon the topic; and
logic which invites the at least one second user to a user group based upon the first quality of fit.

48. The system as recited in claim 43, further comprising:
a first article identified by the first user;
logic that identifies at least one of a plurality of measurements of at least one of a plurality of parts of the first article as relevant data;
wherein the relevant data of the first user includes at least one of the plurality of measurements of the at least one of the plurality of parts of the first article;
the logic which processes the relevant data, includes processing the at least one of the plurality of measurements of the at least one of the plurality of parts of the first article, wherein the processing generates a second quality of fit between the at least one second user and the first article; and
logic which allows the at least one second user access to the second quality of fit.

49. The system as recited in claim 48, further comprising:
the first user defining a user group based upon the topic; and
logic which invites the at least one second user to a user group based upon the second quality of fit.

50. The system as recited in claim 48, further comprising;
the relevant data of the first user including a third quality of fit between the first user and the first article; and
the logic which processes the relevant data, includes processing the third quality of fit.

51. The system as recited in claim 43, further comprising;
a second article identified by the at least one second user;
logic that identifies at least one of a plurality of measurements of at least one of a plurality of parts of the second article as relevant data;
wherein the relevant data of the at lease one second user includes at least one of the plurality of measurements of the at least one of the plurality of parts of the second article, and includes a fourth quality of fit between the second article and the at least one second user;
wherein the logic which processes the relevant data, includes processing the at least one of the plurality of measurements of the at least one of the plurality of parts of the second article and the fourth quality of fit, wherein the processing generates a fifth quality of fit between the second article and the first user;
logic which allows the at least one first user access to the fifth quality of fit.

52. The system as recited in claim 51, further comprising:
the second user defining a user group based upon the topic; and
logic which invites the at least one first user to a user group based upon the fifth quality of fit.

53. The system as recited in claim 43, wherein the database is a centralized database accessible throughout the world.

54. The system as recited in claim 43, further comprising logic that assigns a unique identifier to at least one of the first user and the at least one second user to allow access to the database.

55. The system as recited in claim 54, wherein at least one of the first user and the at least one second user are allowed to access the database by presenting the unique identifier.

56. The system as recited in claim 54, wherein at least one of the first user and the at least one second user go thru a registration process in order to receive the unique identifier.

57. The system as recited in claim 43, further comprising at least one of:
logic to route the second quality of fit from the database to the at least one second user,
logic to allow the at least one second user to communicate with the first user by sending a message to the database, and
logic to allow the first user to communicate with the at least one second user by sending a message to the database.

58. A method of providing international size information for living things and articles comprising the steps of:
collecting body dimension data associated with a user;
the body dimension data including at least one of a plurality of measurements of at least one of a plurality of parts of the body of the user;
storing the body dimension data in a database;
collecting brand size information from at least one brand in a particular country; the brand size information including at least one of, size charts from brand catalogs, size charts from brand web-sites, and size data from a brand data base;
storing the brand size information for the at least one brand in the particular country, in the database;
processing the body dimension data of the user with each of the brand size information of the at least one brand; wherein the processing generates a user size for each of the at least one brand in the particular country;
processing the user size from the at least one brand; wherein the processing generates an international user size for the particular country.

59. The method as recited in claim 58, further comprising:
the body dimension data associated with the user including a user fit preference;
wherein processing the body dimension data of the user with each of the brand size information of the at least one brand, includes processing the user fit preference.

60. The method as recited in claim 58, further comprising:
collecting body dimension data associated with a plurality of second users;
the body dimension data including at least one of a plurality of measurements of at least one of a plurality of parts of the body of the plurality of second users;
storing the body dimension data of the plurality of second users in a database;
processing the body dimension data of the plurality of second users with each of the brand size information of the at least one brand; wherein the processing generates a recommended size standard for the article.

61. The method of claim 60, wherein the processing the body dimension data of the plurality of second users with each of the brand size information of the at least one brand comprises statistical analysis of the data.
